(19) United States
(12) Patent Application Publication
(10) Pub. No.: US 2026/0079716 A1
(43) Pub. Date: Mar. 19, 2026

(54) Load Gathering Techniques

(71) Applicant: Apple Inc., Cupertino, CA (US)

(72) Inventors: Dimitri Tan, Austin, TX (US); Cheng Li, Sunnyvale, CA (US); Tyson J. Bergland, Encinitas, CA (US)

(21) Appl. No.: 18/950,951

(22) Filed: Nov. 18, 2024

Related U.S. Application Data
(60) Provisional application No. 63/696,451, filed on Sep. 19, 2024.

(51) Int. Cl. G06F 9/38; G06F 9/30; G06F 12/0875

(52) U.S. Cl. CPC G06F 9/3888; G06F 9/30043; G06F 12/0875; G06F 2212/452

(57) ABSTRACT

In some embodiments, an apparatus includes execution circuitry configured to execute threads of single-instruction multiple-thread (SIMT) groups. Cache circuitry stores data for multiple registers of a given thread. Coalesce circuitry determines cache line information for SIMT load instructions, while tag circuitry identifies cache hits and misses. Load gather buffer circuitry buffers register data for hits, tracks expected and completed cache line requests, and transmits retrieved data upon completion. The apparatus processes requests with multiple memory addresses, data sizes, and cache line byte offsets. Additional features include rotated gather buffer alignment for parallel read/write support, transpose circuitry for aligning data, and miss gather circuitry with scoreboard tracking and timeout controls for handling cache misses.

### CROSS REFERENCE TO RELATED APPLICATIONS

The present application claims priority to U.S. Provisional App. No. 63/696,451, entitled “Load Gathering Techniques,” filed Sep. 19, 2024, the disclosure of which is incorporated by reference herein in its entirety.

### BACKGROUND

### Technical Field

This disclosure relates generally to computer processors and more particularly to data caches and gathering retrieved cache data.

### Description of Related Art

A graphics processor may include various components such as shader cores, texture units, ray tracing accelerators, etc. Shader cores may execute various types of work, such as compute, vertex, and pixel work. Therefore, caches at certain levels in a cache/memory hierarchy may cache data for multiple clients, multiple memory spaces, etc. Similar situations may arise in various other types of processors, where multiple clients may cache data at a level in a cache/memory hierarchy for different memory spaces. Generally, it may be desirable to reduce bus transactions between caches at different levels or between a cache and another storage structure such as a register file.

### BRIEF DESCRIPTION OF DRAWINGS

FIG. 1A is a diagram illustrating an overview of example graphics processing operations, according to some embodiments.

FIG. 1B is a block diagram illustrating an example graphics unit, according to some embodiments.

FIG. 2 is a block diagram that illustrates an example system with separate load gathering circuitry for cache hits and cache misses, according to some embodiments.

FIG. 3 is a block diagram that illustrates an example of load gather buffer circuitry for cache hits, according to some embodiments.

FIG. 4 is a block diagram illustrating an example shader core that includes data caches and may implement load gathering, according to some embodiments.

FIG. 5 is a diagram illustrating example memory space to thread space transposes, according to some embodiments.

FIG. 6 is a block diagram illustrating a detailed example system with a load gather buffer for cache hits and a load transposer, according to some embodiments.

FIG. 7 is a block diagram illustrating an example load gather buffer data arrangement for four threads, according to some embodiments.

FIG. 8 is a block diagram illustrating an example load transposer with different levels for sub-bank, intra-bank, and inter-bank transposes, according to some embodiments.

FIG. 9 is a block diagram illustrating a detailed load transpose example with a 4 byte chunk size, according to some embodiments.

FIG. 10 is a diagram illustrating an example of a load gather buffer write sequence, according to some embodiments.

FIG. 11 is a block diagram illustrating example miss gather control circuitry and a scoreboard entry for misses, according to some embodiments.

FIG. 12 is a flow diagram illustrating an example method, according to some embodiments.

FIG. 13 is a block diagram illustrating an example computing device, according to some embodiments.

FIG. 14 is a diagram illustrating example applications of disclosed systems and devices, according to some embodiments.

FIG. 15 is a block diagram illustrating an example computer-readable medium that stores circuit design information, according to some embodiments.

### DETAILED DESCRIPTION

A data cache in a graphics processor may be highly complex, e.g., in unified memory architectures, and may be configured to handle requests for multiple memory spaces with different access attributes. For example, U.S. patent application Ser. No. 18/583,520, entitled “Graphics Processor Cache for Data from Multiple Memory Spaces that Supports Multi-Address Parallel Access” and filed Mar. 12, 2024 is incorporated by reference herein in its entirety. The '520 application provides various examples of such a data cache. In this context, certain cache accesses (e.g., for a load instruction for a single-instruction multiple-thread (SIMT) group) may have multiple hits, multiple misses, or both in the data cache.

Generally, it may be desirable to gather data retrieved from the cache before sending it (e.g., to another cache level). Such gathering may reduce bandwidth on the bus between caches and reduce power used to write results to the next cache level (relative to multiple granular writes), for example. In disclosed embodiments, deterministic gather techniques are used for cache hits, e.g., to gather data for all hits in a level 1 (L1) cache before returning the data to a level 0 (L0) cache or register file. For cache misses, miss gather control circuitry may scoreboard misses until a flush event occurs (e.g., a timeout), then allocate and gather data and provide it to another cache level. Disclosed techniques may advantageously provide determinism for hits, reduce bus bandwidth for hits/misses, or both in various embodiments, which may in turn improve performance, reduce power consumption, etc. Disclosed scoreboard techniques for misses may reduce the size of the gather buffer.

### Brief Introduction to Complex Data Cache and Gather/Transpose Techniques

A graphics processor may include multiple shader cores. A given shader core may include thread schedulers, execution units, register and memory resources, and various other sub-blocks. The graphics processor may implement multiple memory spaces, which may be memory backed, e.g., in unified memory architectures (note that non-unified memory embodiments are also contemplated, although disclosed techniques may be particularly useful in the context of unified memory). Example memory spaces may include, but are not limited to, thread private, SIMT (single instruction multiple thread) group scoped, threadgroup scoped, and global spaces. Traditionally, these spaces would have their own separate physical memories/caches, which they might access using different granularities, tags, etc. This approach may involve complex memory access request and data networks.

In some embodiments, a low-level data cache (e.g., an L1 cache) is shared to cache data from various memory spaces (e.g., which may be accessed by different clients). This may advantageously simplify and consolidate request and data networks. The cache may have different tag formats for different memory spaces (and cache requests may identify their memory space as part of the tag to allow proper handling). Various cache circuitry may be parallelized, e.g., to allow parallel tag checks, invalidations, etc. for different address spaces in the same cycle.

To allow multiple simultaneous sub-cache-line granularity accesses from multiple independent requests, the cache may implement a tiered multiple banking configuration that includes multiple tag banks, multiple scheduler banks, multiple data banks and multiple data sub-banks. In such a configuration, each tier of banking may be configured to meet an overall maximum simultaneous request rate and minimum granularity of access. Each request may be mapped via a hash function selected to reduce bank conflicts. Banking may be vertical (row) orientated or horizontal (column) orientated or a combination of both depending on the desired type of simultaneous access at that tier level. Generally, sub-cache-line banking may provide fine granularity cache line (also cacheline) access, tag/scheduler/data banking may provide simultaneous pipelined access to such sub-cache-line accesses, and greater banking may increase rate and reduce bank conflicts when requests can be mapped simultaneously onto banks.

Tag memory space identification information may also facilitate occupancy management, e.g., by selecting cache lines for eviction based at least in part on which memory spaces currently have high cache occupancy.

Note that while an L1 is discussed herein for purposes of discussion, similar techniques may be used for caches at various levels in a cache hierarchy. Further, disclosed caching techniques may be used in non-GPU contexts such as caching for multiple components of a system-on-a-chip, caching for other types of processors such as CPUs, etc.

Generally, the different types of data cached by the shared cache may correspond to different logical memory spaces and are mapped onto the same cache address tag storage and cache data storage (e.g., random access memory (RAM)). The address tag may differentiate each memory space by tagging a given cache line with the corresponding memory type. The data cache may support parallel simultaneous multi-address access (e.g., read+write+atomics) to support streaming SIMT (single-instruction multiple-thread). Parallel accesses may be to different memory types in some situations.

Therefore, speaking generally, the disclosed data cache may: support multiple independent memory spaces that share tag and data storage, allow a given memory space to occupy any percentage of cache (potentially with control or restrictions on occupancy), tag a given cache line with memory space type (mem_type) and memory space identifier (mem_id) (e.g., when there are multiple instantiations of a given memory space type), support parallel tag requests in tag compare logic, support parallel {mem_type, mem_id} compare for simultaneous invalidate (this may allow invalidating all the cached data for a given client in a single cycle, for example), support parallel {mem_type, mem_id} compare for dirty data flush (and data to be flushed may be identified for a given client in a single cycle, for subsequent flushing to a next-level cache), support parallel {mem_type, mem_id} compare for occupancy count, be highly banked for parallel access (which may be combined with address based bank and set hashing for high throughput and high bandwidth performance), provide sub-cache line granularity (fine grained) byte valid+dirty tracking for efficient and parallel sparse access support where sub-cache line granularity (byte chunk range) is memory type dependent (e.g., private memory may access byte chunks of a first size (e.g., N bytes) and device memory may access byte chunks of a second size (e.g., 2N bytes, 1.5N bytes, 4N bytes, etc.), or some combination thereof.

In this context, various cache accesses may be coalesced to determine which accesses relate to the same cache address, e.g., to generate a set of one or more cache line accesses for a given SIMT load instruction. In some instances, the coalescer may group threads that have the same address (e.g., 64-bit address) which may form loads for each unique address. In some aspects, separate paths may be established for triggering and tracking cache hits and misses, while hits and misses may share gather and transpose logic.

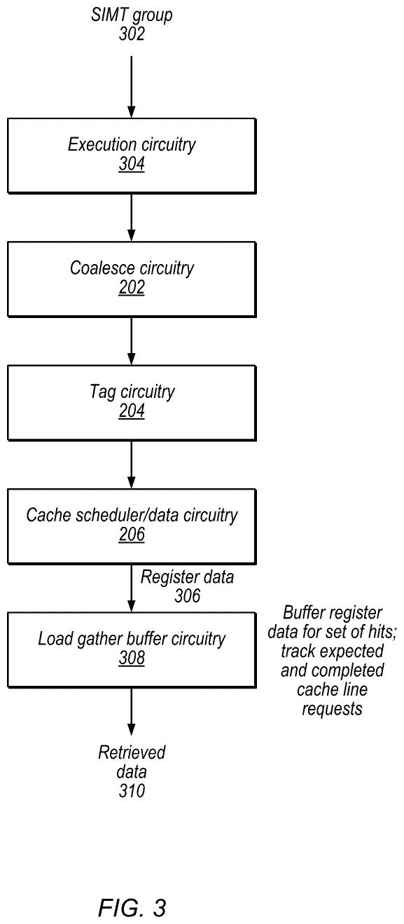

Load gather circuitry for hits may deterministically wait for all coalesced data for hits in the cache to be retrieved before providing the gathered data to the next cache level. Further, the load gather buffer may support various transpose operations, which may advantageously allow accessing data in different alignments (e.g., accessing the same register for N threads, accessing multiple registers for one thread, etc.). FIGS. 3 and 5-10 are discussed in detail below and illustrate example embodiments of such gather and transpose circuitry for cache hits.

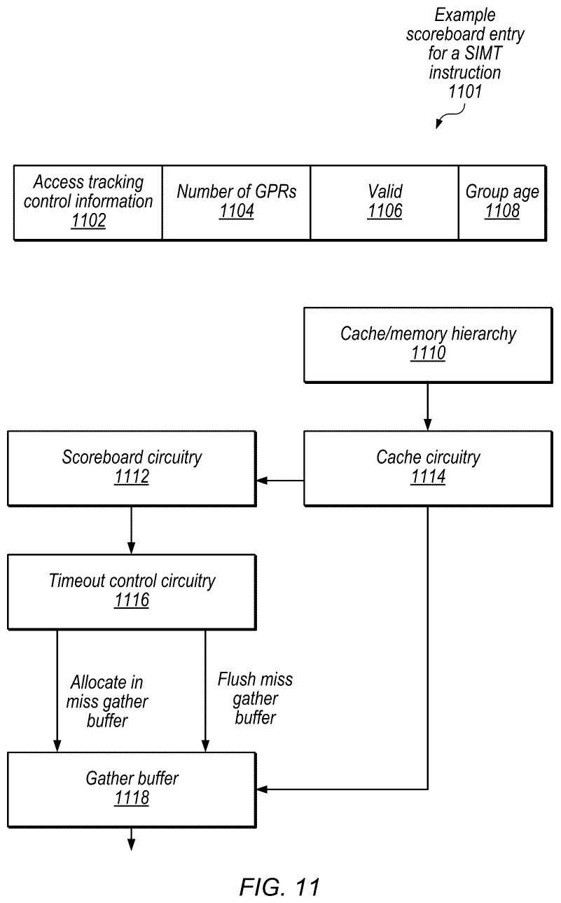

Load gather circuitry for misses may not be deterministic, e.g., because it may be undesirable to wait indefinitely for data with unknown latencies (e.g., to be retrieved from a higher cache or memory). In disclosed embodiments, miss gather circuitry may track scoreboard information for misses and gather fill data for misses in response to certain events such as based on a timeout interval, a threshold amount of data being gathered, etc. FIG. 11 illustrates example embodiments of such gather circuitry for cache misses.

### Graphics Processing Overview

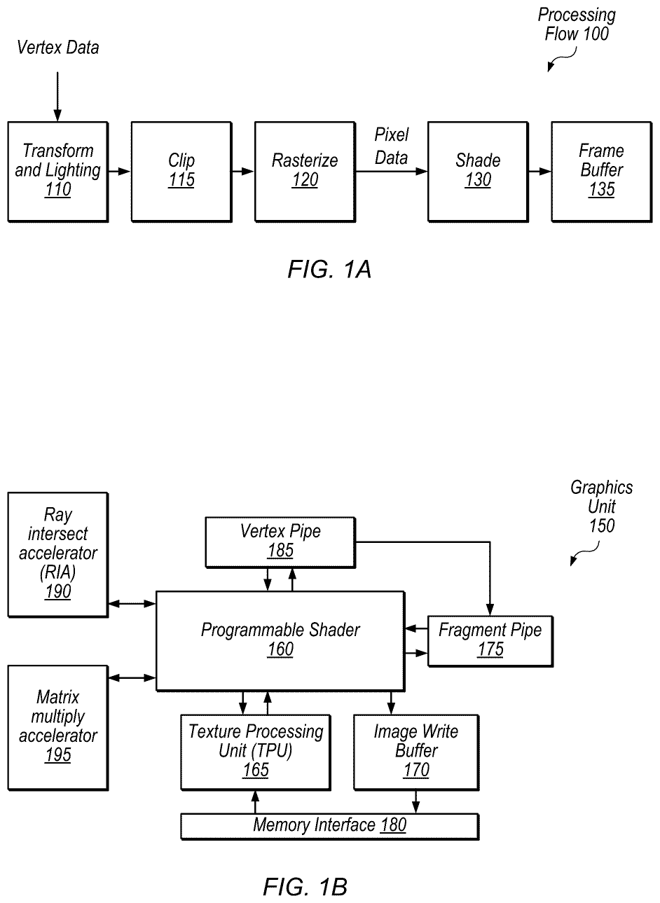

Referring to FIG. 1A, a flow diagram illustrating an example processing flow 100 for processing graphics data is shown. In some embodiments, transform and lighting procedure 110 may involve processing lighting information for vertices received from an application based on defined light source locations, reflectance, etc., assembling the vertices into polygons (e.g., triangles), and transforming the polygons to the correct size and orientation based on position in a three-dimensional space. Clip procedure 115 may involve discarding polygons or vertices that fall outside of a viewable area. In some embodiments, geometry processing may utilize object shaders and mesh shaders for flexibility and efficient processing prior to rasterization. Rasterize procedure 120 may involve defining fragments within each polygon and assigning initial color values for each fragment, e.g., based on texture coordinates of the vertices of the polygon. Fragments may specify attributes for pixels which they overlap, but the actual pixel attributes may be determined based on combining multiple fragments (e.g., in a frame buffer), ignoring one or more fragments (e.g., if they are covered by other objects), or both. Shade procedure 130 may involve altering pixel components based on lighting, shadows, bump mapping, translucency, etc. Shaded pixels may be assembled in a frame buffer 135. Modern GPUs typically include programmable shaders that allow customization of shading and other processing procedures by application developers. Thus, in various embodiments, the example elements of FIG. 1A may be performed in various orders, performed in parallel, or omitted. Additional processing procedures may also be implemented.

Referring now to FIG. 1B, a simplified block diagram illustrating a graphics unit 150 is shown, according to some embodiments. In the illustrated embodiment, graphics unit 150 includes programmable shader 160, vertex pipe 185, fragment pipe 175, texture processing unit (TPU) 165, image write buffer 170, and memory interface 180. In some embodiments, graphics unit 150 is configured to process both vertex and fragment data using programmable shader 160, which may be configured to process graphics data in parallel using multiple execution pipelines or instances.

Vertex pipe 185, in the illustrated embodiment, may include various fixed-function hardware configured to process vertex data. Vertex pipe 185 may be configured to communicate with programmable shader 160 in order to coordinate vertex processing. In the illustrated embodiment, vertex pipe 185 is configured to send processed data to fragment pipe 175 or programmable shader 160 for further processing.

Fragment pipe 175, in the illustrated embodiment, may include various fixed-function hardware configured to process pixel data. Fragment pipe 175 may be configured to communicate with programmable shader 160 in order to coordinate fragment processing. Fragment pipe 175 may be configured to perform rasterization on polygons from vertex pipe 185 or programmable shader 160 to generate fragment data. Vertex pipe 185 and fragment pipe 175 may be coupled to memory interface 180 (coupling not shown) in order to access graphics data.

Programmable shader 160, in the illustrated embodiment, is configured to receive vertex data from vertex pipe 185 and fragment data from fragment pipe 175 and TPU 165. Programmable shader 160 may be configured to perform vertex processing tasks on vertex data which may include various transformations and adjustments of vertex data. Programmable shader 160, in the illustrated embodiment, is also configured to perform fragment processing tasks on pixel data such as texturing and shading, for example. Programmable shader 160 may include multiple sets of multiple execution pipelines for processing data in parallel.

In some embodiments, programmable shader includes pipelines configured to execute one or more different SIMD groups in parallel. Each pipeline may include various stages configured to perform operations in a given clock cycle, such as fetch, decode, issue, execute, etc. The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

The term “SIMD group” is intended to be interpreted according to its well-understood meaning, which includes a set of threads for which processing hardware processes the same instruction in parallel using different input data for the different threads. SIMD groups may also be referred to as SIMT (single-instruction, multiple-thread) groups, single instruction parallel thread (SIPT), or lane-stacked threads. Various types of computer processors may include sets of pipelines configured to execute SIMD instructions. For example, graphics processors often include programmable shader cores that are configured to execute instructions for a set of related threads in a SIMD fashion. Other examples of names that may be used for a SIMD group include: a wavefront, a clique, or a warp. A SIMD group may be a part of a larger threadgroup of threads that execute the same program, which may be broken up into a number of SIMD groups (within which threads may execute in lockstep) based on the parallel processing capabilities of a computer. In some embodiments, each thread is assigned to a hardware pipeline (which may be referred to as a “lane”) that fetches operands for that thread and performs the specified operations in parallel with other pipelines for the set of threads. Note that processors may have a large number of pipelines such that multiple separate SIMD groups may also execute in parallel. In some embodiments, each thread has private operand storage, e.g., in a register file. Thus, a read of a particular register from the register file may provide the version of the register for each thread in a SIMD group.

As used herein, the term “thread” includes its well-understood meaning in the art and refers to sequence of program instructions that can be scheduled for execution independently of other threads. Multiple threads may be included in a SIMD group to execute in lock-step. Multiple threads may be included in a task or process (which may correspond to a computer program). Threads of a given task may or may not share resources such as registers and memory. Thus, context switches may or may not be performed when switching between threads of the same task.

In some embodiments, multiple programmable shader units 160 are included in a GPU. In these embodiments, global control circuitry may assign work to the different sub-portions of the GPU which may in turn assign work to shader cores to be processed by shader pipelines.

TPU 165, in the illustrated embodiment, is configured to schedule fragment processing tasks from programmable shader 160. In some embodiments, TPU 165 is configured to pre-fetch texture data and assign initial colors to fragments for further processing by programmable shader 160 (e.g., via memory interface 180). TPU 165 may be configured to provide fragment components in normalized integer formats or floating-point formats, for example. In some embodiments, TPU 165 is configured to provide fragments in groups of four (a “fragment quad”) in a 2×2 format to be processed by a group of four execution pipelines in programmable shader 160.

Image write buffer 170, in some embodiments, is configured to store processed tiles of an image and may perform operations to a rendered image before it is transferred for display or to memory for storage. In some embodiments, graphics unit 150 is configured to perform tile-based deferred rendering (TBDR). In tile-based rendering, different portions of the screen space (e.g., squares or rectangles of pixels) may be processed separately. Memory interface 180 may facilitate communications with one or more of various memory hierarchies in various embodiments.

As discussed above, graphics processors typically include specialized circuitry configured to perform certain graphics processing operations requested by a computing system. This may include fixed-function vertex processing circuitry, pixel processing circuitry, or texture sampling circuitry, for example. Graphics processors may also execute non-graphics compute tasks that may use GPU shader cores but may not use fixed-function graphics hardware. As one example, machine learning workloads (which may include inference, training, or both) are often assigned to GPUs because of their parallel processing capabilities. Thus, compute kernels executed by the GPU may include program instructions that specify machine learning tasks such as implementing neural network layers or other aspects of machine learning models to be executed by GPU shaders. In some scenarios, non-graphics workloads may also utilize specialized graphics circuitry, e.g., for a different purpose than originally intended.

Further, various circuitry and techniques discussed herein with reference to graphics processors may be implemented in other types of processors in other embodiments. Other types of processors may include general-purpose processors such as CPUs or machine learning or artificial intelligence accelerators with specialized parallel processing capabilities. These other types of processors may not be configured to execute graphics instructions or perform graphics operations. For example, other types of processors may not include fixed-function hardware that is included in typical GPUs. Machine learning accelerators may include specialized hardware for certain operations such as implementing neural network layers or other aspects of machine learning models. Speaking generally, there may be design tradeoffs between the memory requirements, computation capabilities, power consumption, and programmability of machine learning accelerators. Therefore, different implementations may focus on different performance goals. Developers may select from among multiple potential hardware targets for a given machine learning application, e.g., from among generic processors, GPUs, and different specialized machine learning accelerators.

In the illustrated example, graphics unit 150 includes ray intersection accelerator (RIA) 190, which may include hardware configured to perform various ray intersection operations in response to instruction(s) executed by programmable shader 160, as described in detail below.

In the illustrated example, graphics unit 150 includes matrix multiply accelerator 195, which may include hardware configured to perform various matrix multiply operations in response to instruction(s) executed by programmable shader 160, as described in detail below.

### Example of Separate Load Gathering for Cache Hits and Cache Misses

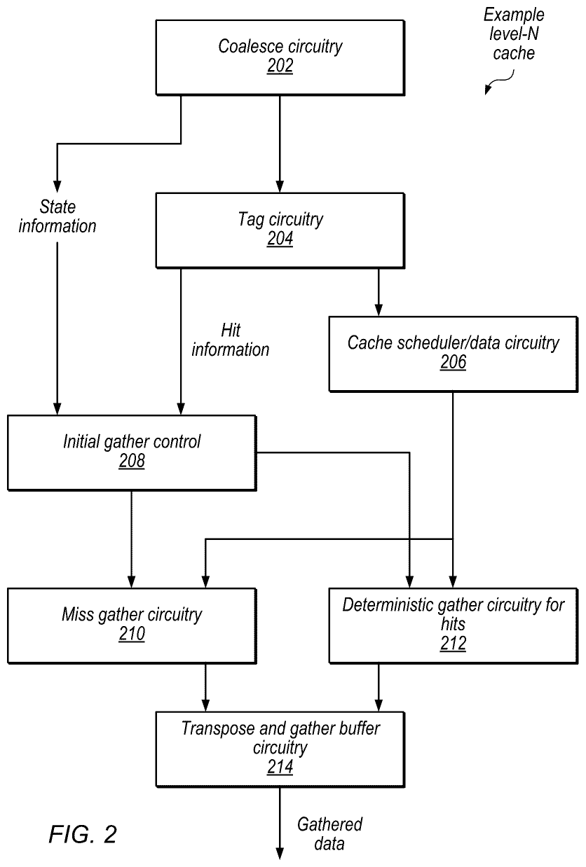

FIG. 2 is a block diagram that illustrates an example system with separate load gathering circuitry for cache hits and cache misses, according to some embodiments. In the illustrated example, a level-N cache includes coalesce circuitry 202, tag circuitry 204, cache scheduler/data circuitry 206, initial gather control circuitry 208, miss gather circuitry 210, deterministic gather circuitry 212 for hits, and transpose and gather buffer circuitry 214.

Coalesce circuitry 202, in some embodiments, is responsible for generating state information for a given cache access by a SIMT group. By way of example, multiple threads may execute the same instruction, but some threads may be predicated off and not active for a particular instruction. Additionally, different instructions may access registers of different sizes (e.g., 32-bit floating point, 16-bit integer, etc.). Coalesce circuitry 202 may compare the load memory address across the threads in a SIMT group and coalesce threads that access the same cache line into a single cache line request. Each cache line request may be uniquely identifiable, and the threads associated with each request may be tracked. In some cases, coalesced cache line requests may be dispatched to the appropriate tag bank of tag circuitry 204 in parallel.

Tag circuitry 204, in some embodiments, is configured to compare various corresponding fields (e.g., a portion of an address) from a tag check request and cache line tag state for a given cache line. Tag check circuitry 204 may provide a hit or miss result for a given tag check request. Tag circuitry 204 may implement multiple tag banks which may enable parallel tag checks, as discussed in the '520 application. Tag compare logic may be replicated across ways of a set, in set-associative implementations. Tag compare logic, in some embodiments, is configured to perform tag checks for multiple memory spaces with different tag formats in parallel. In some embodiments, this involves multiple parallel instances of tag comparison logic, even beyond parallelization required for set associativity.

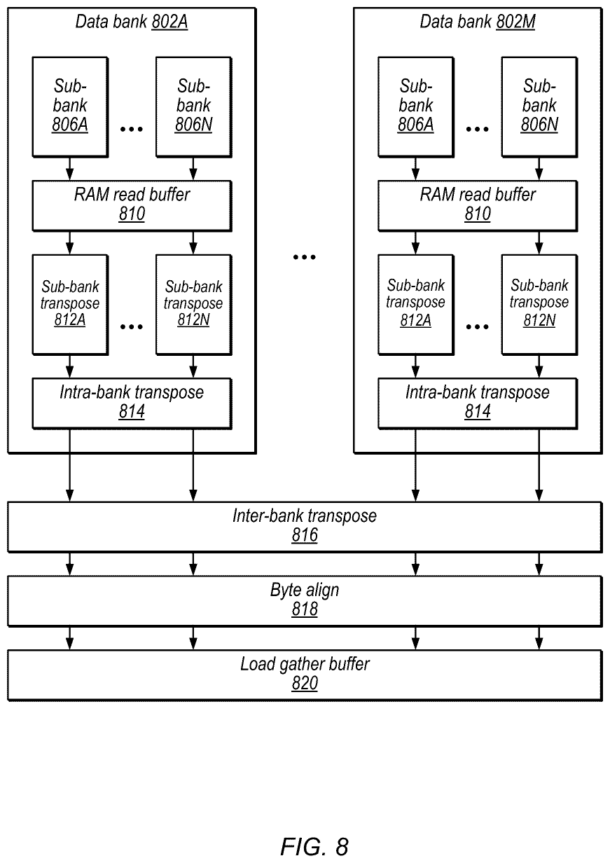

Cache scheduler/data circuitry 206, in some embodiments, is configured to access data banks for hits indicated by tag circuitry 206 and may also generate fill requests from other cache levels for misses indicated by tag circuitry 206. In some cases, when there is a cache hit, circuitry 206 may determine the corresponding data banks in the cache and coordinate reading those banks. Example data bank and sub-bank structures are discussed below with reference to FIG. 8, for example.

Initial gather control circuitry 208, in some embodiments, coordinates the data gathering process. For example, initial gather control circuitry 208 may receive state information from the coalesce circuitry 202 and hit information from the tag circuitry 204. Based on this information, circuitry 208 may direct gather operations. In the illustrated example, for cache hits, initial gather control 208 is configured to direct deterministic gather circuitry for hits 212 to gather all the relevant data before it is sent to the appropriate location (e.g., such as a DL0 for general-purpose register (GPR) data). For cache misses, initial gather control 208 is configured to direct miss gather circuitry 210 to gather data when appropriate, e.g., as discussed in detail below with reference to FIG. 11.

Deterministic gather circuitry for hits 212, in some embodiments, is configured to ensure all the data for the hits is gathered before being sent. In other embodiments, circuitry 212 may deterministically gather data but may send the data over multiple beats, e.g., sending half or a third of the gathered data once that half or third is complete, etc.

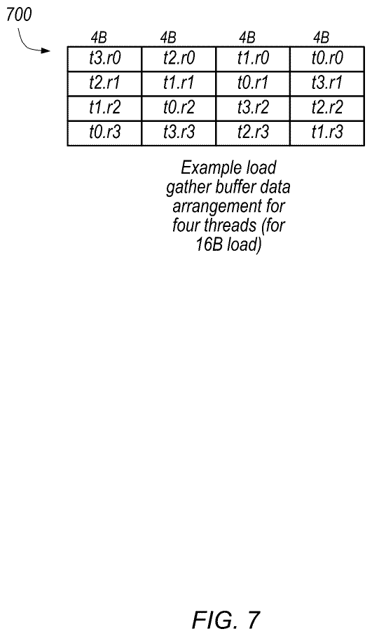

Transpose and gather buffer circuitry 214, in the illustrated embodiment, is configured to store gathered data and potentially transpose it. Detailed example embodiments of circuitry 214 are discussed in detail below with reference to FIGS. 7-10. As shown, the gather buffer and transpose circuitry are shared for hits and misses, in this example. In other implementations, separate buffers may be maintained for gathered data for hits and misses.

For cache misses, initial gather control 208, circuitry 206, or both may fetch the data from higher levels of the memory hierarchy (e.g., such as an L2 cache, L3 cache, or main memory (e.g., DRAM)). In some instances, miss gather circuitry 210 handles the process of gathering the data from these higher levels. In some examples, the gathered miss data may be buffered in-place in the level-N cache temporarily. Once accumulated or in response to a timeout, it may be sent back to minimize bandwidth usage and improve performance. In some cases, this process is non-deterministic due to the varying latency of responses from higher memory levels.

### Example Deterministic Load Gathering for Cache Hits

FIG. 3 is a block diagram that illustrates an example of load gather buffer circuitry for cache hits, according to some embodiments. In the illustrated example, a system includes execution circuitry 304, coalesce circuitry 202, tag circuitry 204, cache scheduler/data circuitry 206, and load gather buffer circuitry 308. Similarly-numbered elements may be configured as discussed above with reference to FIG. 2.

Execution circuitry 304, in some embodiments, is configured to execute threads of SIMT groups 302. For example, execution circuitry 304 may include all or a portion of a shader pipeline. Execution circuitry may include load/store circuitry configured to process load instructions and generate memory access requests. Circuitry 202-206 may operate as described above.

Load gather buffer circuitry 308 is one example of circuitry 212. In some embodiments, load gather buffer 308 is configured to buffer register data retrieved from cache circuitry 206 for a set of hits (e.g., determined by tag circuitry 204). In some embodiments, load gather buffer circuitry 308 tracks expected and completed cache line requests for the SIMT load instruction and transmits retrieved data 310 from cache circuitry 206 only in response to the completion of all expected cache line requests for the SIMT load instruction.

In some cases, load gather buffer circuitry 308 and/or other components may implement a deterministic control mechanism that tracks the number of expected and completed cache line requests per SIMT group (e.g., N threads for N-wide SIMT) load instruction. For example, this capability may advantageously deliver a high-load data return bandwidth for a range of address patterns and instruction sequences when coupled with a high-throughput, minimal-blocking transposer and a highly-banked load gather buffer that supports parallel simultaneous write access in column format and read access in row format. The determinism may increase the achievable load data return bandwidth and reduce inconsistent behavior caused by temporal fluctuations in request ordering and processing. In other words, disclosed systems may absorb an amount of temporal imbalance, particularly if the depth of the load gather buffer is tuned to the latency of the input pipelines and the request and transposer rates are properly configured.

Note that while SIMT instructions are discussed herein for purposes of illustration, load operations may access multiple cache lines that may be gathered in other contexts as well. SIMT instructions are included for purposes of illustration but are not intended to limit the context of disclosed gather techniques.

### Example of Unified Shader Core (USC)

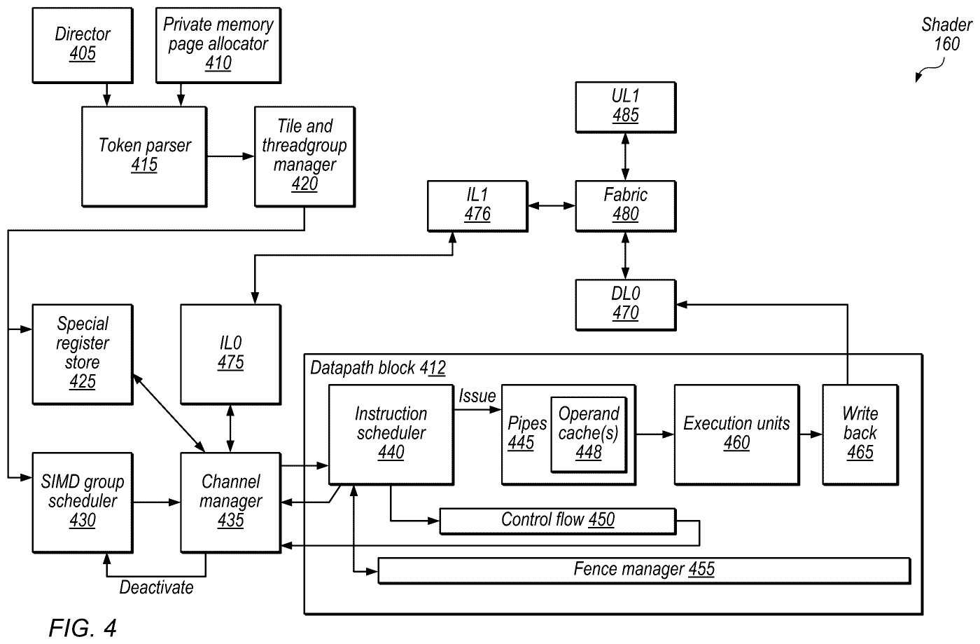

FIG. 4 is a block diagram illustrating an example shader that includes data caches and may implement load gathering, according to some embodiments. In some embodiments, disclosed gather techniques may be used for data accessed from the UL1 cache 485, for example.

In the illustrated embodiment, shader 160 includes director 405, private memory page allocator 410, token parser 415, tile and threadgroup manager 420, special register store 425, SIMD group scheduler 430, channel manager 435, datapath block 412, data level 0 (DL0) cache 470, instruction level 0 cache (IL0) 475, instruction level 1 (IL1) cache 476, fabric 480, and unified level 1 (UL1) cache 485.

Director circuitry 405 may provide work from multiple data masters (e.g., a compute data master, vertex data master, and pixel data master) to token parser 415. Private memory page allocator 410 may allocate pages for private memory spaces, as requested by token parser 415. Note that elements 405 and 410 may be external to shader 160 and may communicate with multiple shaders 160.

Token parser 415, in some embodiments, is configured to receive work tokens from multiple data masters, form SIMD groups, and interact with allocator 410 to allocate pages for private memory.

Tile and threadgroup manager 420, in some embodiments, is configured to coordinate execution of SIMD groups within a tile (e.g., for pixel work) or threadgroup (e.g., for compute work). This may include enforcing various types of synchronization, for example.

SIMD group scheduler 430, in some embodiments, is configured to manage SIMD-group-scoped state information and identify highest-priority SIMT groups that are ready to execute, according to an arbitration scheme. The arbitration scheme may be primarily age-based but may also consider other factors.

Channel manager circuitry 435, in some embodiments, is configured to fetch instructions and dispatch them to instruction scheduler 440. It may manage channel activation and deactivation, manage the program counter for a given SIMD group, manage architectural state (e.g., accessing special register store 425, which may implement SIMD-group-scoped architectural special registers such as the program counter), fetch instructions, and dispatch instructions. Channel manager 435 may read the special register store 425 when activating a SIMD group into a channel and write special register store 425 when deactivating a SIMD group from a channel.

Datapath block 412, in some embodiments, is configured to execute dispatched instructions and may include channel pipelines and shared execution pipelines. Datapath block 412 may be instantiated multiple times in a given GPU. In the illustrated embodiment, datapath block 412 includes instruction scheduler 440, pipeline circuitry 445, operand caches 448, execution units 460, write back circuitry 465, control flow circuitry 450, and fence manager 455.

Instruction scheduler 440, in some embodiments, is configured to manage execution resources inside datapath block 412 and schedule individual instruction execution. This may include fine decode of incoming instructions, sequencing microoperations, data dependency and hazard detection, managing a read operand cache and write buffer circuitry, priority-based instruction scheduling, generating read and write requests to IL0 475, generating pipeline control signals, and enforcing SIMD group deactivations.

Pipelines 445 may include one or more math pipelines (which may execute floating-point, integer, and iterate instructions, for example), one or more address generator pipelines (e.g., for load, store, atomic, sample, and image write instructions), and one or more control flow units (shown separately as control flow circuitry 450) configured to execute conditional and branch instructions. Execution units 460 may perform various types of operations for the pipelines 445. As shown, operand cache(s) 448 may be the lowest level of operand storage. Write-back stage 465 may write results to DL0. Note that write operations may be posted.

Fence manager circuitry 455, in some embodiments, is configured to ensure that data dependencies outside of datapath block 412 are maintained. As discussed in detail below, fence manager 455 may implement fence counters per SIMD group per fence (e.g., where a non-zero fence count indicates an outstanding dependency). Fence manager 455 may also implement an ordered instruction queue per channel (referred to as a channel queue) to tracked pipelined fences for committed instructions. In some embodiments, fence manager 455 may trigger deactivation of a channel in certain situations.

DL0 cache 470, in some embodiments, is configured to cache all or a portion of registers included in thread private memory. In some embodiments, a given DL0 cache 470 is associated with one datapath block 412. Instruction scheduler 440 may initiate tag lookups in DL0 cache 470.

IL0 cache 475, in some embodiments, is the lowest-level instruction cache and is configured to provide instructions to one or more stages of channel manager 435. IL1 cache 476, in some embodiments, is configured to respond to fill requests from IL0 cache 475 and may retrieve instruction data from UL1 cache 485 via fabric 480 for misses.

Fabric circuitry 480, in some embodiments, is a packet-switched network that provides communication between a number of shader modules. As some examples of communications via fabric circuitry 480, caches may access thread-private memory, the token parser 415 may initialize SIMD group and threadgroup state stored in UL1 prior to launching a SIMD group, sampling and image write pipes may read interface-private memory, texture processing results may be forwarded to stack registers, vertex circuitry may send fetch requests for vertex data, IL1 cache 476 may request IL1 miss data from global memory, global memory may receive evictions and line fill requests, etc.

UL1 cache 485, in some embodiments, is a unified instruction and data cache configured to store data evicted from IL1 cache 476 and DL0 cache 470. In other embodiments, IL1 cache 476 is a read-only cache that may retrieve data from UL1 cache 485 but does not evict data to IL1.

Example Transpose from Memory Space to Thread Space for Deterministic Gather Buffer

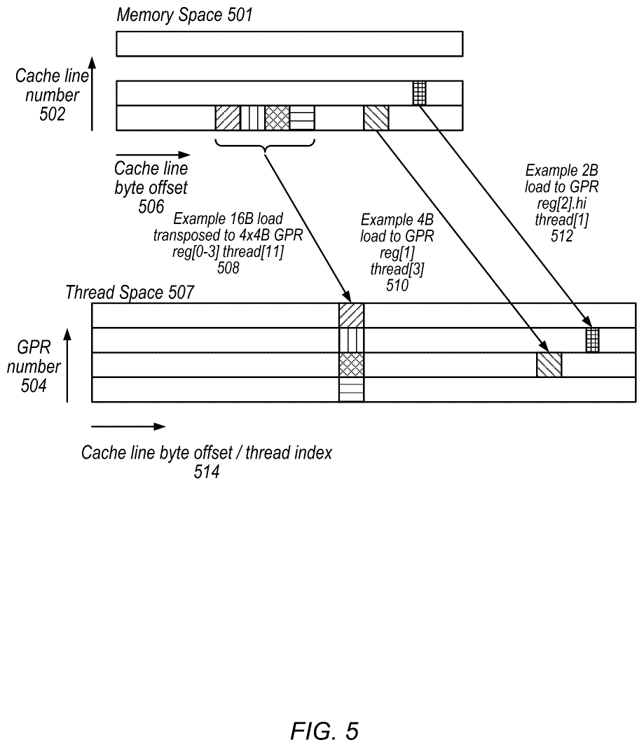

FIG. 5 is a diagram illustrating an example of memory space to thread space transposing, according to some embodiments. Generally, threads may operate within the thread address space while data may be transposed for caching, as discussed in detail below, using various techniques.

Memory space 501, in the illustrated example, is organized by cache lines (e.g., according to cache line number 502) with a number of bytes at different offsets (e.g., offsets 506) in a given cache line. In some aspects, a load transposer may read the load data from data RAMs organized according to memory space 501 and transpose it into the corresponding thread space data by writing into the load gather buffer 308.

Thread space 507, in the illustrated example, is organized by general-purpose register (GPR) numbers 504 and each is indexed according to cache line byte offset and thread indices 514. In some examples, this structure allows for various organized transposes of data from memory space 501 to thread space 507.

The three slanted arrows of FIG. 5 show three examples of different sizes of load data transposed from memory space 501 to thread space 507. As a first example, transpose 508 involves a 16-byte (16 B) load from memory space 501 into four 4-byte (4 B) GPR entries in thread space 507 (e.g., corresponding to registers 0-3 of thread 11, as indicated by example 16 B load transposed to 4×4 B GPR reg[0-3] thread[11] 508). In other examples, load may retrieve a similar size of data for multiple threads, e.g., four 4-byte data chunks may correspond to the same register number for four different threads.

As a second example, transpose 510 involves a 4-byte load from memory space 501 into the GPR entry for register 1 of thread 3 in thread space 507. As a third example, transpose 512 involves a 2-byte (2 B) load from memory space 501 into the high sixteen bits of the GPR entry for register 2 of thread 1 in thread space 507.

In some embodiments, the load gather buffer entries are allocated as each SIMT-instruction first wins arbitration (e.g., by determining the priority of different instructions and resolving conflicts when multiple instructions compete for the same resources). In the example embodiment of FIG. 5, the number of 4 B destination GPRs determines the number of load gather buffer entries required.

As evidenced by these examples, loads may retrieve cached data of various widths and transpose (or not) retrieved data into a desired format in thread space.

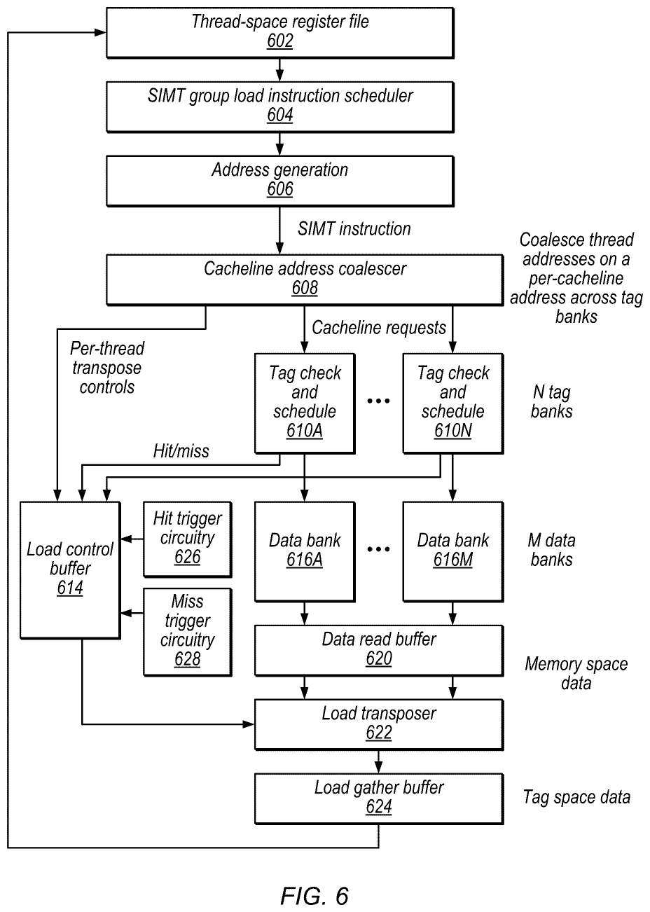

FIG. 6 is a block diagram illustrating a detailed example system with a load gather buffer for cache hits and a load transposer, according to some embodiments. In the illustrated example, the system includes thread-space register file 602, SIMT group load instruction scheduler circuitry 604, address generation circuitry 606, cacheline address coalescer 608, tag check and schedule circuitry 601A-610N, load control buffer 614, data banks 616A-616M, data read buffer circuitry 620, load transposer 622, load gather buffer 624, hit trigger circuitry 626, and miss trigger circuitry 628.

Register file 602, in some embodiments, is configured to store general-purpose register data, e.g., organized according to thread space 507. Register file 602 may be a more traditional register file or may be a level 0 data cache (e.g., DL0 470).

SIMT group load instruction scheduler 602, in some embodiments, is configured to schedule a load instruction and receive operand data corresponding to the thread-space register file (e.g., an identification of one or more target registers). Scheduler 602 may compute the load memory address for all the threads in a SIMT group and send this information cacheline address coalescer 608.

Cacheline address coalescer 608, in some embodiments, is configured to compare the load memory address across threads of the SIMT group (e.g., 8, 16, 32, 64, etc. threads, depending on the SIMT group size) and coalesce threads that access the same cache line into a single cache line request. For example, each cache line request may be uniquely identifiable and the threads associated with each cache line request may be identified. In some aspects, the cache line requests may be dispatched to the appropriate tag bank in parallel. In some examples, the dispatched cache line requests may be counted and recorded on a per-SIMT-instruction basis in the load control buffer 614 along with the per thread cache line byte address offset and per thread cache line request identified and the per SIMT-instruction load format and size information and destination register for the load return data. In some cases, cacheline address coalescer 608 may allocate sufficient entries in the load gather buffer 624 to receive all the load data expected for the SIMT-instruction.

Tag check and schedule circuits 610 in some embodiments, upon receipt of a load cache line request, are configured to perform the corresponding tag check to determine if the cache line address is a cache hit or a cache miss. This information may be forwarded to load control buffer 614 where the number of cache line hits and number of cache line misses may be counted (e.g., on a per-SIMT-instruction basis). In some aspects, in the case of a hit cache line request, a corresponding RAM read to data bank circuitry 616 may be scheduled and the data read from the cache line may be written to data read buffer 620 (e.g., a RAM read buffer). Next, the load transpose request may be scheduled and dispatched to load transposer 622.

Hit trigger circuitry 626 is configured to trigger gathering for hits automatically and tag check hit count is used to track completion. Miss trigger circuitry 628 is configured to trigger gathering for misses using event-based triggers (e.g., comparing a pending fill return count to a threshold, a delay timeout, etc.). Both triggers may utilize an expected request count and a completed request count to determine when all expected data has been gathered. Thus, once triggered, miss gathering may be treated the same as hit gathering, in some embodiments, although the miss gathering is non-deterministic until triggered.

Load transposer 622, in some embodiments, is configured to receive load transpose requests from data bank schedulers. Each load transpose request may include the unique cache line request identified, a pointer to the corresponding load control buffer 614 entry and a pointer to the data read buffer 620 entry. The unique cache line request identified may be used to determine which threads are associated with that particular cache line request. In some instances, for each associated thread, the per thread information contained in the load control buffer 614 is read and decoded into transpose controls. The source data for transposing may be read out of data read buffer 620 and delivered to the datapath of transposer 622. In some embodiments, the resulting transposed data is written into the load gather buffer 624.

Load gather buffer 624, in some embodiments, is configured to receive and store transposed load data that is aligned in thread-space. For example, the number of hit cache line requests that have been processed (e.g., load data transposed and written to load gather buffer 624) may be tracked on a SIMT-instruction basis. Load control buffer 614 may also track various appropriate information for indirect load operations. In some cases, once all the expected load hit data has been transposed into thread-space and gathered for a SIMT-instruction, then that data may be returned to the register file and written to the appropriate registers.

In some embodiments, the various stages in the load transpose and load gathering system as illustrated in FIG. 6 may be parallelized through multiple instantiations of units and sub-units by using multiple banking arrangements with simultaneous access support. In some instances, the level of parallelization may be selected to achieve a target throughput amount. By way of example, the following arrangement may be selected to achieve a processing rate of 1 SIMT-wide load instruction per cycle with a load data return rate of 1 SIMT-wide register per cycle for properly-arranged access patterns. The address generation 606 for a SIMT-instruction may be performed in parallel for 32 threads and fully pipelined to support a processing rate of 1 SIMT-instruction per cycle per address generation unit. The cacheline address coalescing 608 may be performed in parallel for all 32-threads with an output rate equal to the maximum tag check rate. In some examples, the tag logic may be banked to support multiple tag checks in parallel per cycle. The number of tag banks, T, may determine the maximum tag check rate. In some cases, the data read buffer 620 logic may be banked to support multiple cacheline reads per cycle. The number of data banks 616, D, may determine the maximum RAM read rate. Each data bank 616 may be further partitioned into K sub-banks where each sub-bank is associated with a sub-range of a cache line. For example, a 64 B cache line may be divided into K=4 sub-banks each covering a 16 B range. Each sub-bank within a data bank 616 may access a different cache line simultaneously. In some examples, this banking arrangement may support processing of multiple cache line requests in parallel each cycle. The maximum number of cache line requests which may be processed in parallel each cycle corresponds to D*K. This may require that data bank 616 data read operations (e.g., via data read buffer 620) are scheduled on a RAM sub-bank basis. In some examples, load transposer 622 may receive D*K sub-bank granular transpose requests in parallel each cycle. To match this input rate, load transposer 622 may be similarly partitioned where parallel transposer logic is instanced on a per sub-bank basis and per data bank 616 basis. In some embodiments, because the output of the transposer is per thread, the transposer logic is also parallelized on a thread basis. In some cases, load gather buffer 614 is banked on a per thread lane basis to allow parallel writes to all lanes. In some embodiments, the preceding arrangement may be scaled up by adding more parallel hardware or scaled down by reducing hardware and taking multiple cycles to sequence through an operation.

FIG. 7 is a block diagram illustrating an example load gather buffer data arrangement for four threads, according to some embodiments. In the example illustrated in FIG. 7, a sample arrangement of load data for 4 threads in the gather buffer for load instructions with 16 B per thread is shown. The threads are denoted by t0, t1, t2, t3. The 4 B destination registers are denoted by r0, r1, r2, r3. Each 4 B column can be addressed independently. The threads are rotated relative to each other to allow for parallel access on a thread basis (e.g., {t0.r3, t0.r2, t0.r1, t0.r0} or on a register basis {t3.r2, t2.r2, t1.r2, t0.r2}). FIGS. 8-10, discussed in detail below provide detailed examples of bank and transpose circuitry and techniques for storing load data in the example load gather buffer organization of FIG. 7.

In some embodiments, the load transposer is a multi-input and multi-output byte granular switch. There are multiple possible implementations of this switch, e.g., as an arrangement of multiplexers. By way of example, assuming an input of N bytes and an output of M bytes, the transposer may be described as an N:M switch. In some aspects, a fully-parallel switch may include M instances of an N:1 byte granular switch or multiplexer, and such a switch may be characterized as non-blocking (e.g., since there is a path from every input to every output). In some cases, from a hardware implementation perspective, such a fully parallel switch may be computationally expensive and unnecessary. Conversely, in some examples a serial switch where only one input to output path may be supported at a given time. Between these examples, a parallel switch may consist of a multi-level network of switches where each level may be of a different granularity and/or connectivity. In some embodiments, such a switch is characterized as blocking, since certain combinations of input to output paths are not possible, and one or more paths will be blocked. In some cases, these restrictions may result in a reduction in hardware implementation cost while supporting the most common cases in a parallel method. The transposer may also be referred to as alignment, shift, rotate, shuffle, or permute circuitry and may perform any appropriate combination of those functions.

As discussed above, in the context of a processor memory sub-system, the transposer may transform data from one memory space or layout to another memory space or layout. Further, the transposer may be used to store data in the load gather buffer. Generally, a load gather buffer is a storage structure that accumulates or gathers load data from a group of load operations. For example, in this context, a SIMT group may execute a load where each thread has a different address, and the load data is passed through the transposer such that it aligns to the storage associated with each thread. In some instances, the load gather buffer may be a multi-banked arrangement to support parallel writes from transposed load data and may also support parallel reads, to return thread data in parallel.

FIG. 8 is a block diagram illustrating an example load transposer with different levels for sub-bank, intra-bank, and inter-bank transposes, according to some embodiments. In the illustrated example, a cache is implemented using multiple data banks 802A-802M and a given data bank 802 in turn includes multiple sub-banks 806A-806N and a RAM read buffer 810. In this example, transpose circuitry is hierarchically arranged to perform transpose operations at different levels, including sub-bank transpose circuitry 812A-812N for a given bank, interbank transpose circuitry 814 for a given bank, inter-bank transpose circuitry 816, byte align circuitry 818, and load gather buffer 820.

In the illustrated example, there are M data banks 802 each partitioned into N sub-banks (e.g., RAM sub-banks). The sub-banks may be accessed in parallel in a given cycle to access data stored in a bank's RAM read buffer 810. As shown, the transposer may include parallel per sub-bank transposers 812 configured to potentially transpose data from a corresponding sub-bank 806. The outputs of the sub-bank transposers 812 are merged at an intra data bank level (e.g., via intra-bank transpose 814) and then merged again at an inter-bank level (e.g., via inter-bank transpose 816). The transposed results are then byte aligned by circuitry 818 before being written into load gather buffer 820. In some embodiments, the transposer assumes the sub-bank 812, intra data bank 814 and inter-bank 816 transposers operate on a multibyte granularity (which may be referred to as chunk) to save hardware, and the byte level alignment is deferred to the last stage directly prior to writing the load gather buffer 820.

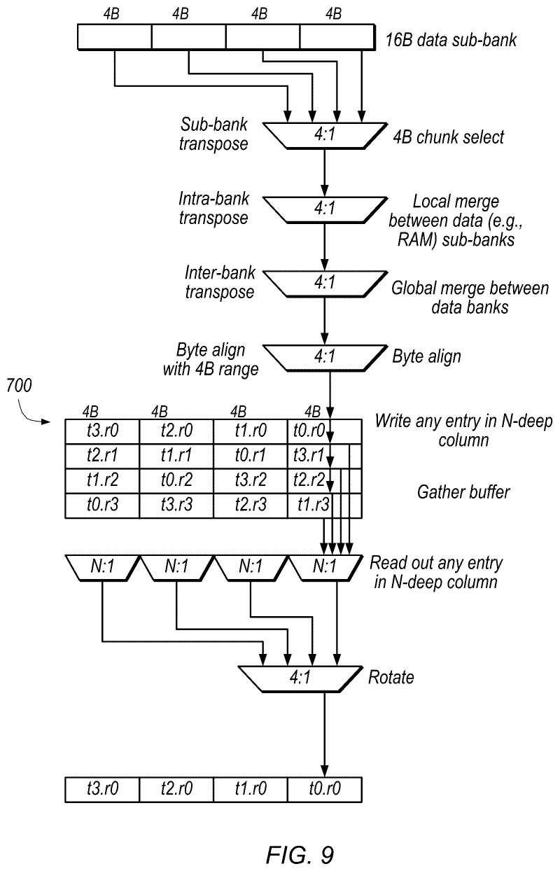

FIG. 9 is a block diagram illustrating a detailed load transpose example with a 4 byte chunk size, according to some embodiments. In the example of FIG. 9, an arrangement with a 4 B chunk size and 4 B destination columns is shown. In some embodiments, the 4 B chunk size is used at each level. In other embodiments, other chunk sizes may be used; further, different levels may use different chunk sizes. Note that the chunk size may be inversely proportional to the hardware cost (e.g., the larger the chunk size, the lower the hardware cost but the greater the chance of one path being blocked by another, which may add transpose cycles and lower efficiency).

In the illustrated example, the sub-bank transpose is implemented using a 4:1 MUX that selects a 4 B chunk from a 16 B data sub-bank read. Similar 4:1 multiplexers are used at the next three levels for intra-bank transpose (and a local merge between sub-banks), inter-bank transpose (and a global merge between data banks), and byte alignment. As shown, the output of the byte alignment may be written into any row of the corresponding N-deep column in the gather buffer. In various embodiments, load control buffer may control the multiplexers of the load transposer based on the desired data read format, state information that indicates coalesce results, etc. In the example of FIG. 9, the data is transposed such that the same GPR is stored in a given row of the load gather buffer, but various other organizations may be implemented, e.g., by controlling the multiplexers, storing data using a different organization in a sub-bank, etc. In the illustrated example, an N:1 multiplexer per column is configured to read out any entry of the column. (Generally, the load gather buffer may support flexibility in writing to row or columns, reading to rows of columns, or both, in order to support various desired granularities and formats.

In some cases a granular rotator, such as the 4 B rotator illustrated in FIG. 9, may be used on the output of the load gather buffer to align thread data at the output. In the illustrated example, four threads' (t0-t3) version of register r0 is provided. In other situations, multiple registers for one thread may be provided. In still other situations, various access patterns may be implemented, e.g., with P registers from each of Q threads provided in a given cycle. As discussed above, control circuitry may deterministically wait until the load gather buffer has gathered data for all threads for a given SIMT load instruction before providing the data, which may advantageously reduce bus transactions and interference with other memory traffic.

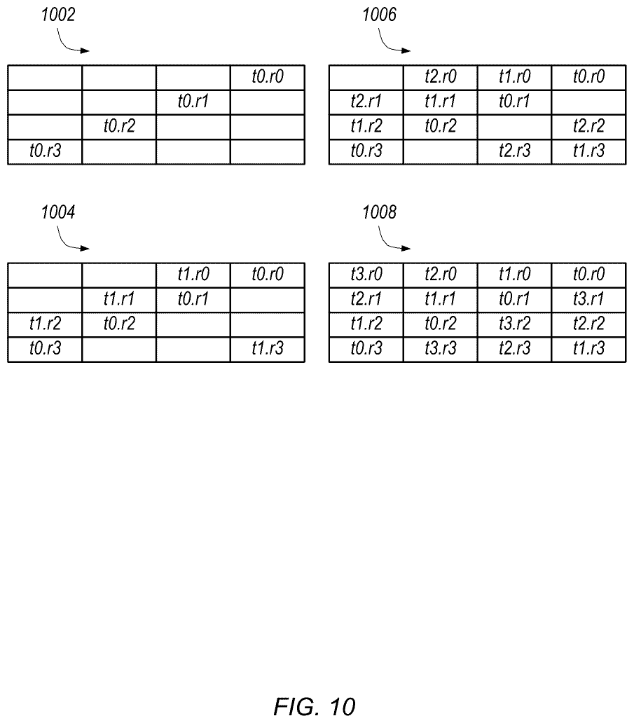

FIG. 10 is a diagram illustrating an example of a load gather buffer write sequence, according to some embodiments. In the example illustration of FIG. 10, writes to a load gather are sequenced across four cycles 1002-1008 for a 16 B-per-thread load operation. In the illustrated example, three registers for thread 0 (r0-r3) are written in cycle 1002. Referring back to FIG. 5, nearby registers for a given thread may be stored in the same cacheline or sub-cacheline and therefore may be accessed from the same data bank and transposed for storage in the desired locations in the load gather buffer for transferring to thread space once gather is complete. In cycle 1004 the registers for thread 1 are written into the load gather buffer, followed by thread 2 in cycle 1006 and thread 3 in cycle 1008.

In various embodiments, disclosed techniques with granular, parallel cache bank access, transpose circuitry, and deterministic load gather buffer tracking may advantageously provide efficient bus use for load data with bounded latency (e.g., because the worst-case blocking scenario can be modeled, while the transpose circuitry may have no blocking or limited blocking for may common workloads).

### Example Miss Gather Techniques

As discussed above, in some embodiments the system includes separate miss gather control that is non-deterministic and may return portions of its gathered results for an overall load (e.g., a SIMT load instruction) at different times. In some embodiments, miss gather control circuitry may track (e.g., using a scoreboard) when miss data is filled into the cache and wait to actually allocate space in the gather buffer until a timeout event occurs. Note that the timeout events may be tracked in an efficient manner in terms of complexity and power, e.g., using a group age rather than a timeout counter per entry. Disclosed miss gather techniques may advantageously improve bus efficiency while reducing circuit area (e.g., relative to a larger gather buffer in implementations without scoreboarding), reducing power consumption, etc.

FIG. 11 is a block diagram illustrating example miss gather control and a scoreboard entry, according to some embodiments. In the illustrated example, the system includes cache/memory hierarchy 1110, cache circuitry 1114, scoreboard circuitry 1112, timeout control circuitry 1116, and gather buffer 1118. Note that cache circuitry 1114 may correspond to data banks 616, for example and miss control circuitry may utilize load control buffer 614 to track various aspects of miss gathering.

Scoreboard circuitry 1112, in the illustrated example, is configured to track status of fill operations that populate data for misses in cache circuitry 1114. FIG. 11 shows an example scoreboard entry 1101 of circuitry 1112. In the illustrated example, a given scoreboard entry for a SIMT instruction includes access tracking control information 1102, number of GPRs 1104, valid status 1106, and group age 1108. Scoreboard circuitry 1112 may support multiple such entries to track multiple different SIMT instructions with misses. Example functionality of the various circuitry of FIG. 11 is described below in conjunction with corresponding fields of a scoreboard entry 1101.

Access tracking control information 1102, in some embodiments, is generated by coalescer 202, tag circuitry 204, initial gather control 208, or some combination thereof, and may indicate which cache locations correspond to requested load data to be filled (from cache/memory hierarchy 1110 which may include various appropriate levels of cache circuitry, memory circuitry, or both). Generally, the access tracking control information may be used to determine when and where fill data is pending or available.

The number of GPRs indicated by field 1104, in some embodiments, indicates the number of registers for which load data needs to be available before completion of the SIMT load instruction. Once this number is reached, timeout control circuitry 1116 may allocate, populate, and flush the gather buffer (note that timeout control circuitry 1116 may also perform these operations based on timeout scenarios, as discussed in detail below).

Valid field 1106 indicates whether the scoreboard entry is valid (e.g., entries may be invalidated and eligible for allocation for another SIMT instruction once all data for a SIMT instruction has been transmitted from the gather buffer 1118).

Group age field 1108, in some embodiments, indicates the age of a group of instructions, e.g., for timeout purposes. This field may be controlled by a counter, for example, that increments every N clock cycles or every N instructions. In other embodiments, the group age 1108 is stamped for a group of instructions within a certain time or space proximity, based on a moving pointer value, and the moving pointer is compared with stamped scoreboard entry ages every N cycles (where a threshold difference from the moving pointer value triggers timeout action(s)). When the group age 1108 meets a threshold, timeout control circuitry 1116 may allocate space in the gather buffer 1118 for the SIMT instruction and flush that portion of the gather buffer (e.g., to DL0 cache 470) once the indicated data is retrieved from the cache circuitry 1114 into the allocated space in the gather buffer 1118.

If the SIMT instruction is not complete when a timeout flush occurs, its age may be reset and it may continue to scoreboard fill results until another timeout occurs or until all fill data for the SIMT instruction has been filled (at which point a final allocation and flush may occur, as discussed above).

Note that timeout counter information may be maintained at different granularities in different embodiments. In some embodiments, each SIMT instruction may have its own timeout value. This may be expensive in hardware terms, however, so other embodiments may maintain a group age value, counter, pointer value, etc. for a window of instructions.

Note that disclosed transpose circuitry may be configured to populate and read from gather buffer 1118 similarly to disclosed techniques relating to the buffer 308. Buffer circuitry may be shared for hits and misses or may be independent.

In some embodiments, control circuitry is configured to allow read operations to proceed out of program order. For example, a subsequent hit on a miss may have a dependency on the waiting cache lines and this dependency slow scheduling. Linked lists may be used to track dependencies on a given cacheline for misses. In some embodiments, control circuitry is configured to ignore read after read dependencies once write dependencies are properly resolved, allowing multiple reads from different load instructions to be scheduled at the same time.

### Example Method

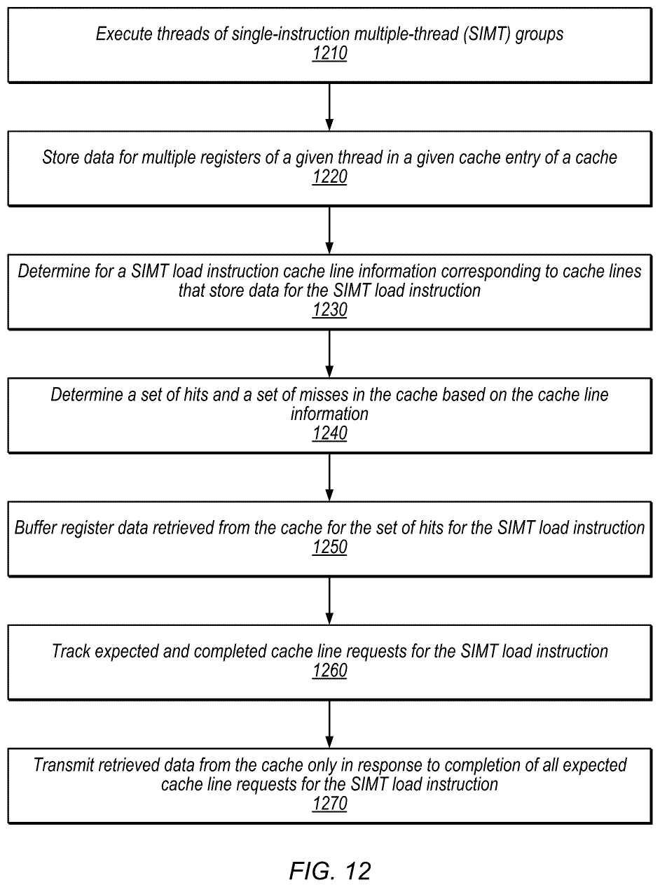

FIG. 12 is a flow diagram illustrating an example method, according to some embodiments. The method shown in FIG. 12 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 1210, in the illustrated embodiment, a computing system (e.g., execution circuitry 304) executes threads of single-instruction multiple-thread (SIMT) groups.

At 1220, in the illustrated embodiment, the computing system data for multiple registers of a given thread in a given cache entry of a cache (e.g., cache circuitry 206) stores. In some embodiments, the cache stores data for multiple registers of a given thread in a given cache entry of a cache. In some embodiments, the cache stores data for multiple threads in a given cache entry.

At 1230, in the illustrated embodiment, the computing system (e.g., coalesce circuitry 202) determines, for a SIMT load instruction, cache line information corresponding to cache lines that store data for the SIMT load instruction.

At 1240, in the illustrated embodiment, the computing system (e.g., tag circuitry 204) determines a set of hits and a set of misses in the cache based on the cache line information.

At 1250, in the illustrated embodiment, a load gather buffer (e.g., load gather buffer circuitry 308) of the computing system buffers register data retrieved from the cache for the set of hits for the SIMT load instruction.

At 1260, in the illustrated embodiment, the load gather buffer tracks expected and completed cache line requests for the SIMT load instruction. For example, the number of hit cache line requests that have been processed (e.g., transposed and written to the load gather buffer) may be tracked on a SIMT-instruction basis.

At 1270, in the illustrated embodiment, the load gather buffer transmits retrieved data from the cache only in response to completion of all expected cache line requests for the SIMT load instruction. For example, once all the expected load hit data has been transposed into thread-space and gathered for a SIMT-instruction, then that data may be returned to the DL0 cache/register file.

In some embodiments, the computing system (e.g., cache circuitry 206, coalesce circuitry 202, tag circuitry 204, etc. or some combination thereof) is further configured to process cache requests having multiple different memory addresses for different threads within one of the SIMT group, multiple different data sizes, and multiple different cache line byte offsets.

In some embodiments, the load gather buffer is further configured to store buffered register data in a row/column format with common registers from different threads aligned within a given row or within a given column, and the computing system is further configured to read a row of the buffered register data in a first cycle and read a column of the buffered register data in a second cycle. For example, a rotated data arrangement (e.g., load gather buffer data arrangement 700) may include threads rotated relative to each other for parallel access on a thread basis or on a register basis.

In some embodiments, the computing system (e.g., transpose circuitry such as one or more components of FIG. 8 or load transposer 622 of FIG. 6) is further configured to read data from different banks of the cache circuitry, potentially in parallel.

In some embodiments, the cache includes multiple data banks (e.g., data banks 802A through 802M) and the data banks include multiple sub-banks (e.g., sub-banks 806A through 806N) and is configured to store a cache entry across multiple sub-banks and the computing system is configured to access different cache entries of different sub-banks in a given cycle.

In some embodiments, the load gather buffer is further configured to enable parallel access to data stored within the load gather buffer on a per-thread basis, including an access for a first thread of a SIMT group and an access for a second thread of a SIMT group in a given cycle. In some embodiments, the load gather buffer is further configured to enable parallel access to data stored within the load gather buffer circuitry on a per-register basis, including an access for a first register of a first thread and a second register of the first thread in a given cycle. For example, the load gather buffer may be multi-banked arranged to support parallel writes from transposed load data and also support parallel reads to return thread data in parallel.

In some embodiments, the computing system (e.g., scoreboard circuitry 1112) is configured to track, in a first entry for a set of misses in the cache (e.g., cache circuitry 1114) corresponding to the cache line information determined by the computing system (e.g., coalesce circuitry 202) for the SIMT load instruction, whether corresponding data has been retrieved to the cache from another cache or memory (e.g., cache/memory hierarchy 1110).

In some embodiments, the computing system (e.g., one or more components of FIG. 11) is configured to buffer register data retrieved to the cache for the set of misses, allocate space in the computing system in response to the first entry indicating completion of data retrieval for all misses in the set of misses, and allocate space in the gather circuitry in response to expiration of a timeout interval associated with the first entry of the computing system (e.g., scoreboard circuitry 1112).

### Example Device

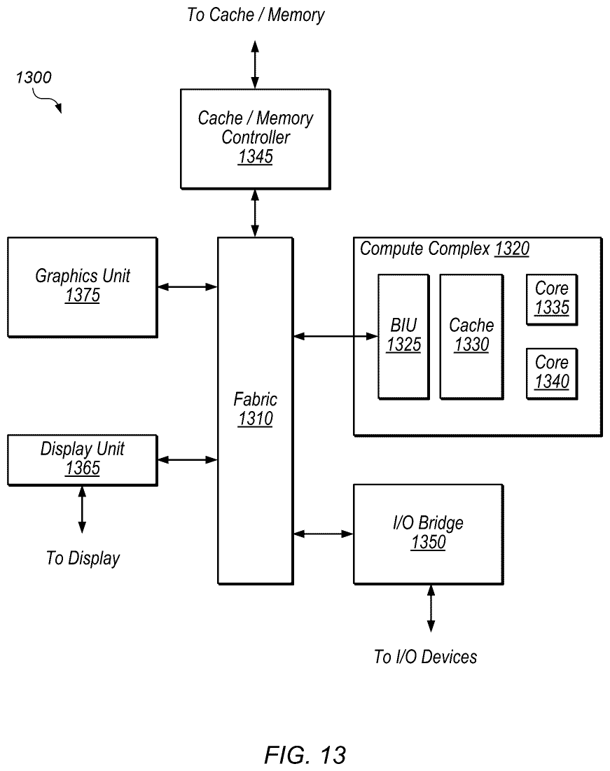

Referring now to FIG. 13, a block diagram illustrating an example embodiment of a device 1300 is shown. In some embodiments, elements of device 1300 may be included within a system on a chip. In some embodiments, device 1300 may be included in a mobile device, which may be battery-powered. Therefore, power consumption by device 1300 may be an important design consideration. In the illustrated embodiment, device 1300 includes fabric 1310, compute complex 1320 input/output (I/O) bridge 1350, cache/memory controller 1345, graphics unit 1375, and display unit 1365. In some embodiments, device 1300 may include other components (not shown) in addition to or in place of the illustrated components, such as video processor encoders and decoders, image processing or recognition elements, computer vision elements, etc.

Fabric 1310 may include various interconnects, buses, MUX's, controllers, etc., and may be configured to facilitate communication between various elements of device 1300. In some embodiments, portions of fabric 1310 may be configured to implement various different communication protocols. In other embodiments, fabric 1310 may implement a single communication protocol and elements coupled to fabric 1310 may convert from the single communication protocol to other communication protocols internally.

In the illustrated embodiment, compute complex 1320 includes bus interface unit (BIU) 1325, cache 1330, and cores 1335 and 1340. In various embodiments, compute complex 1320 may include various numbers of processors, processor cores and caches. For example, compute complex 1320 may include 1, 2, or 4 processor cores, or any other suitable number. In one embodiment, cache 1330 is a set associative L2 cache. In some embodiments, cores 1335 and 1340 may include internal instruction and data caches. In some embodiments, a coherency unit (not shown) in fabric 1310, cache 1330, or elsewhere in device 1300 may be configured to maintain coherency between various caches of device 1300. BIU 1325 may be configured to manage communication between compute complex 1320 and other elements of device 1300. Processor cores such as cores 1335 and 1340 may be configured to execute instructions of a particular instruction set architecture (ISA) which may include operating system instructions and user application instructions. These instructions may be stored in computer readable medium such as a memory coupled to memory controller 1345 discussed below.

Note that while various GPU embodiments are discussed herein, similar techniques may be used for various processors with clients that access a cache in different ways, potentially including embodiment of compute complex 1320, other caches of the illustrated system, etc.

As used herein, the term “coupled to” may indicate one or more connections between elements, and a coupling may include intervening elements. For example, in FIG. 13, graphics unit 1375 may be described as “coupled to” a memory through fabric 1310 and cache/memory controller 1345. In contrast, in the illustrated embodiment of FIG. 13, graphics unit 1375 is “directly coupled” to fabric 1310 because there are no intervening elements.

Cache/memory controller 1345 may be configured to manage transfer of data between fabric 1310 and one or more caches and memories. For example, cache/memory controller 1345 may be coupled to an L3 cache, which may in turn be coupled to a system memory. In other embodiments, cache/memory controller 1345 may be directly coupled to a memory. In some embodiments, cache/memory controller 1345 may include one or more internal caches. Memory coupled to controller 1345 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 1345 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 1320 to cause the computing device to perform functionality described herein.

Graphics unit 1375 may include one or more processors, e.g., one or more graphics processing units (GPUs). Graphics unit 1375 may receive graphics-oriented instructions, such as OPENGL®, Metal®, or DIRECT3D® instructions, for example. Graphics unit 1375 may execute specialized GPU instructions or perform other operations based on the received graphics-oriented instructions. Graphics unit 1375 may generally be configured to process large blocks of data in parallel and may build images in a frame buffer for output to a display, which may be included in the device or may be a separate device. Graphics unit 1375 may include transform, lighting, triangle, and rendering engines in one or more graphics processing pipelines. Graphics unit 1375 may output pixel information for display images. Graphics unit 1375, in various embodiments, may include programmable shader circuitry which may include highly parallel execution cores configured to execute graphics programs, which may include pixel tasks, vertex tasks, and compute tasks (which may or may not be graphics-related).

In some embodiments, disclosed techniques may advantageously improve performance, power consumption, etc. of graphics unit 1375, relative to implementations that do not implement various disclosed shared data cache techniques.

Display unit 1365 may be configured to read data from a frame buffer and provide a stream of pixel values for display. Display unit 1365 may be configured as a display pipeline in some embodiments. Additionally, display unit 1365 may be configured to blend multiple frames to produce an output frame. Further, display unit 1365 may include one or more interfaces (e.g., MIPI® or embedded display port (eDP)) for coupling to a user display (e.g., a touchscreen or an external display).

I/O bridge 1350 may include various elements configured to implement: universal serial bus (USB) communications, security, audio, and low-power always-on functionality, for example. I/O bridge 1350 may also include interfaces such as pulse-width modulation (PWM), general-purpose input/output (GPIO), serial peripheral interface (SPI), and inter-integrated circuit (I2C), for example. Various types of peripherals and devices may be coupled to device 1300 via I/O bridge 1350.

In some embodiments, device 1300 includes network interface circuitry (not explicitly shown), which may be connected to fabric 1310 or I/O bridge 1350. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 1300 with connectivity to various types of other devices and networks.

### Example Applications

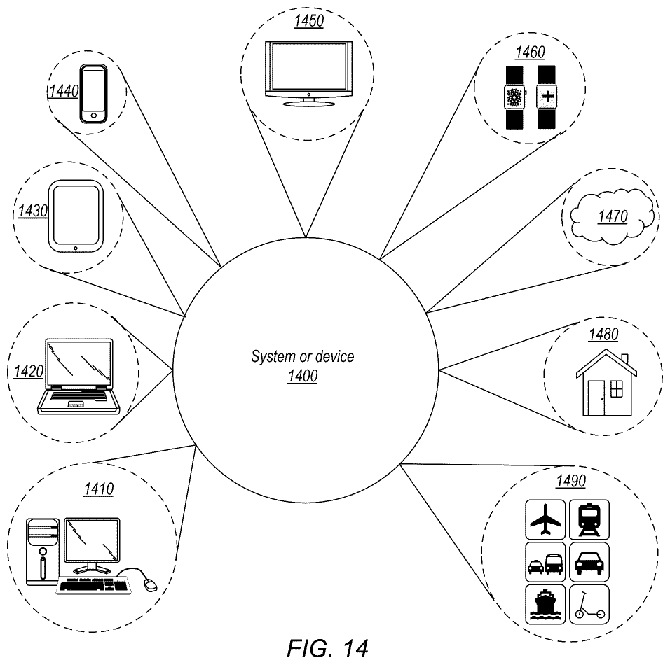

Turning now to FIG. 14, various types of systems that may include any of the circuits, devices, or system discussed above. System or device 1400, which may incorporate or otherwise utilize one or more of the techniques described herein, may be utilized in a wide range of areas. For example, system or device 1400 may be utilized as part of the hardware of systems such as a desktop computer 1410, laptop computer 1420, tablet computer 1430, cellular or mobile phone 1440, or television 1450 (or set-top box coupled to a television).

Similarly, disclosed elements may be utilized in a wearable device 1460, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1400 may also be used in various other contexts. For example, system or device 1400 may be utilized in the context of a server computer system, such as a dedicated server or on shared hardware that implements a cloud-based service 1470. Still further, system or device 1400 may be implemented in a wide range of specialized everyday devices, including devices 1480 commonly found in the home such as refrigerators, thermostats, security cameras, etc. The interconnection of such devices is often referred to as the “Internet of Things” (IoT). Elements may also be implemented in various modes of transportation. For example, system or device 1400 could be employed in the control systems, guidance systems, entertainment systems, etc. of various types of vehicles 1490.

The applications illustrated in FIG. 14 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

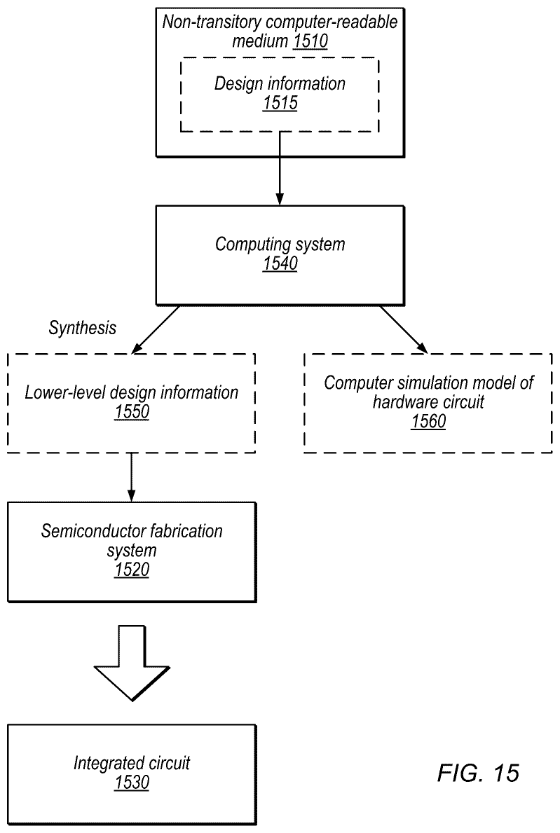

FIG. 15 is a block diagram illustrating an example non-transitory computer-readable storage medium that stores circuit design information, according to some embodiments. In the illustrated embodiment, computing system 1540 is configured to process the design information. This may include executing instructions included in the design information, interpreting instructions included in the design information, compiling, transforming, or otherwise updating the design information, etc. Therefore, the design information controls computing system 1540 (e.g., by programming computing system 1540) to perform various operations discussed below, in some embodiments.

In the illustrated example, computing system 1540 processes the design information to generate both a computer simulation model of a hardware circuit 1560 and lower-level design information 1550. In other embodiments, computing system 1540 may generate only one of these outputs, may generate other outputs based on the design information, or both. Regarding the computing simulation, computing system 1540 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1540 also processes the design information to generate lower-level design information 1550 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1550 (potentially among other inputs), semiconductor fabrication system 1520 is configured to fabricate an integrated circuit 1530 (which may correspond to functionality of the simulation model 1560). Note that computing system 1540 may generate different simulation models based on design information at various levels of description, including information 1550, 1515, and so on. The data representing design information 1550 and model 1560 may be stored on medium 1510 or on one or more other media.

In some embodiments, the lower-level design information 1550 controls (e.g., programs) the semiconductor fabrication system 1520 to fabricate the integrated circuit 1530. Thus, when processed by the fabrication system, the design information may program the fabrication system to fabricate a circuit that includes various circuitry disclosed herein.

Non-transitory computer-readable storage medium 1510, may comprise any of various appropriate types of memory devices or storage devices. Non-transitory computer-readable storage medium 1510 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1510 may include other types of non-transitory memory as well or combinations thereof. Accordingly, non-transitory computer-readable storage medium 1510 may include two or more memory media; such media may reside in different locations—for example, in different computer systems that are connected over a network.

Design information 1515 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 1540, semiconductor fabrication system 1520, or both. In some embodiments, design information may also include one or more cell libraries that specify the synthesis, layout, or both of integrated circuit 1530. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1530 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1520 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1520 may also be configured to perform various testing of fabricated circuits for correct operation.

In various embodiments, integrated circuit 1530 and model 1560 are configured to operate according to a circuit design specified by design information 1515, which may include performing any of the functionality described herein. For example, integrated circuit 1530 may include any of various elements shown in FIGS. 1B-4, 6, 8-9, 11, and 13. Further, integrated circuit 1530 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1520 to fabricate integrated circuit 1530.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
execution circuitry configured to execute threads of single-instruction multiple-thread (SIMT) groups;
cache circuitry configured to store, in a given cache entry, data for multiple registers of a given thread;
coalesce circuitry configured to determine, for a SIMT load instruction executed by the execution circuitry, cache line information corresponding to cache lines that store data for the SIMT load instruction;
tag circuitry configured to determine, based on the cache line information, a set of hits and a set of misses in the cache circuitry;
load gather buffer circuitry configured to:
buffer register data retrieved from the cache circuitry for the set of hits determined by the tag circuitry for the SIMT load instruction;
track expected and completed cache line requests for the SIMT load instruction; and
transmit retrieved data from the cache circuitry only in response to completion of all expected cache line requests for the SIMT load instruction.

2. The apparatus of claim 1, wherein the cache circuitry, coalesce circuitry, and tag circuitry is configured to process cache requests having:
multiple different memory addresses for different threads within one of the SIMT group;
multiple different data sizes; and
multiple different cache line byte offsets.

3. The apparatus of claim 1, wherein the load gather buffer circuitry is further configured to:
store buffered register data in a row/column format with common registers from different threads aligned within a given row or within a given column; and
control circuitry configured to:
read a row of the buffered register data in a first cycle; and
read a column of the buffered register data in a second cycle.

4. The apparatus of claim 3, further comprising:
transpose circuitry configured to read data from different banks of the cache circuitry; and
align data retrieved from the different banks into rows and columns of the buffered register data.

5. The apparatus of claim 4, wherein:
the cache circuitry includes multiple data banks and the data banks include multiple sub-banks;
the cache circuitry is configured to store a cache entry across multiple sub-banks; and
control circuitry is configured to access different cache entries of different sub-banks in a given cycle.

6. The apparatus of claim 1, wherein the load gather buffer circuitry is further configured to enable parallel access to data stored within the load gather buffer circuitry on a per-thread basis, including an access for a first thread of a SIMT group and an access for a second thread of a SIMT group in a given cycle.

7. The apparatus of claim 1, wherein the load gather buffer circuitry is further configured to enable parallel access to data stored within the load gather buffer circuitry on a per-register basis, including an access for a first register of a first thread and a second register of the first thread in a given cycle.

8. The apparatus of claim 1, further comprising:
scoreboard circuitry configured to track, in a first entry for a set of misses in the cache circuitry corresponding to the cache line information determined by the coalesce circuitry for the SIMT load instruction, whether corresponding data has been retrieved to the cache circuitry from another cache or memory.

9. The apparatus of claim 8, further comprising:
miss control circuitry configured to:
allocate space in the load gather buffer circuitry in response to the first entry indicating completion of data retrieval for all misses in the set of misses; and
allocate space in the load gather buffer circuitry in response to expiration of a timeout interval associated with the first entry of the scoreboard circuitry.

10. A method, comprising:
executing, by a computing system, threads of single-instruction multiple-thread (SIMT) groups;
storing, by the computing system, data for multiple registers of a given thread in a given cache entry of a cache;
determining, by the computing system, for a SIMT load instruction, cache line information corresponding to cache lines that store data for the SIMT load instruction;
determining, by the computing system, a set of hits and a set of misses in the cache based on the cache line information;
buffering, by a load gather buffer of the computing system, register data retrieved from the cache for the set of hits for the SIMT load instruction;
tracking, by the load gather buffer, expected and completed cache line requests for the SIMT load instruction; and
transmitting, by the load gather buffer, retrieved data from the cache only in response to completion of all expected cache line requests for the SIMT load instruction.

11. The method of claim 10, wherein the computing system is further configured to process cache requests having:
multiple different memory addresses for different threads within one of the SIMT group;
multiple different data sizes; and
multiple different cache line byte offsets.

12. The method of claim 10, wherein the load gather buffer is further configured to:
store buffered register data in a row/column format with common registers from different threads aligned within a given row or within a given column; and
wherein the computing system is further configured to:
read a row of the buffered register data in a first cycle; and
read a column of the buffered register data in a second cycle.

13. The method of claim 10, wherein the computing system is further configured to read data from different banks of the cache and align data retrieved from the different banks into rows and columns of the buffered register data.

14. A non-transitory computer-readable medium having instructions of a hardware description programming language stored thereon that, when processed by a computing system, program the computing system to generate a computer simulation model, wherein the model represents a hardware circuit that includes:
execution circuitry configured to execute threads of single-instruction multiple-thread (SIMT) groups;
cache circuitry configured to store, in a given cache entry, data for multiple registers of a given thread;
coalesce circuitry configured to determine, for a SIMT load instruction executed by the execution circuitry, cache line information corresponding to cache lines that store data for the SIMT load instruction;
tag circuitry configured to determine, based on the cache line information, a set of hits and a set of misses in the cache circuitry;
load gather buffer circuitry configured to:
buffer register data retrieved from the cache circuitry for the set of hits determined by the tag circuitry for the SIMT load instruction;
track expected and completed cache line requests for the SIMT load instruction; and
transmit retrieved data from the cache circuitry only in response to completion of all expected cache line requests for the SIMT load instruction.

15. The non-transitory computer-readable medium of claim 14, wherein the cache circuitry, coalesce circuitry, and tag circuitry is configured to process cache requests having:
multiple different memory addresses for different threads within one of the SIMT group;
multiple different data sizes; and
multiple different cache line byte offsets.

16. The non-transitory computer-readable medium of claim 14, wherein the load gather buffer circuitry is further configured to:
store buffered register data in a row/column format with common registers from different threads aligned within a given row or within a given column; and
control circuitry configured to:
read a row of the buffered register data in a first cycle; and
read a column of the buffered register data in a second cycle.

17. The non-transitory computer-readable medium of claim 16, further comprising:
transpose circuitry configured to read data from different banks of the cache circuitry; and
align data retrieved from the different banks into rows and columns of the buffered register data.

18. The non-transitory computer-readable medium of claim 17, wherein:
the cache circuitry includes multiple data banks and the data banks include multiple sub-banks;
the cache circuitry is configured to store a cache entry across multiple sub-banks; and
control circuitry is configured to access different cache entries of different sub-banks in a given cycle.

19. The non-transitory computer-readable medium of claim 14, wherein the load gather buffer circuitry is further configured to enable parallel access to data stored within the load gather buffer circuitry on a per-thread basis, including an access for a first thread of a SIMT group and an access for a second thread of a SIMT group in a given cycle.

20. The non-transitory computer-readable medium of claim 14, wherein the load gather buffer circuitry is further configured to enable parallel access to data stored within the load gather buffer circuitry on a per-register basis, including an access for a first register of a first thread and a second register of the first thread in a given cycle.
